(19) United States
(12) Patent Application Publication
(10) Pub. No.: US 2011/0113002 A1
(43) Pub. Date: May 12, 2011

(54) METHOD FOR PATIENT GENOTYPING

(76) Inventors: Michael D. Kane, West Lafayette, IN (US); John A. Springer, West Lafayette, IN (US); Jon K. Sprague, Bluffton, OH (US); Nicholas Iannotti, Palm City, FL (US)

(21) Appl. No.: 12/735,911

(22) PCT Filed: Feb. 26, 2009
(86) PCT No.: PCT/US09/35332

§ 371 Date: Jan. 28, 2011

Related U.S. Application Data
(60) Provisional application No. 61/031,527, filed on Feb. 26, 2008.

(51) Int. Cl. G06N 5/02

(52) U.S. Cl. 706/50

(57) ABSTRACT

The present invention is a system and method for utilizing human genetic and genomic information to guide prescription dispensing and improved drug safety in a pharmacy setting. The system and method of the present invention utilizes a dedicated information management system and software to utilize patient-specific genetic information to screen for increased risk of adverse drug reactions and therapeutic responses at the time of drug dispensing.

### CROSS-REFERENCE

This application claims the benefit of priority to U.S. Provisional Application No. 61/031,527 filed on Feb. 26, 2008 which is herein incorporated by reference in its entirety.

### BACKGROUND OF THE INVENTION

The present invention relates to a system and method for utilizing human genetic and genomic information to guide prescription dispensing and improve drug safety. All publications cited in this application are herein incorporated by reference.

The success of the worldwide genomics efforts will ultimately be measured by the translation of genomic science into clinical products which affect the practice of medicine and the process by which the biotechnology and the pharmaceutical industries develop successful commercial drugs and other therapeutic products. The utilization of genomic and proteomic data to establish new targets by which to screen new chemical entities as prospective therapeutic agents is rapidly becoming mainstream for drug discovery worldwide. The application of genomics to the clinical development and use of drugs, however, is now in its earliest phase. Bioinformatics platforms provide computational and software tools which enable rapid mining of the enormous genetic sequence, mutation and functional data for a given gene. It is estimated that 2 of 5,000 compounds identified from the drug discovery process eventually reach the clinical market. Once a lead drug candidate is chosen for clinical development, the clinical trial process involves Food and Drug Agency in the United States (FDA) oversight for Phases I-III. Following successful completion of the clinical trial process, the data are submitted to the respective regulatory agency (eg., FDA) as part of the New Drug Application (NDA) process. Regulatory scrutiny, however, does not end with the FDA approval for a drug to be introduced into the market. Post-marketing surveillance (PMS) is, in essence, an ongoing clinical trial in the Phase N category. Although identification and categorization of adverse events is a critical element throughout all Phases of the clinical trial process, the total population exposed to a drug in clinical development typically ranges from 1,000-3,000 people. While extensive, this sample size does not account for the potential side effects that could occur in the tens or hundreds of thousands (or millions) of people taking the drug when it is available for administration to the general population. Moreover, a pharmaceutical company may be required to conduct a Phase IV study, usually in untested populations such as children and the elderly, to extend approved indications into age specific areas.

Pharmacogenomics, the use of genomic information to guide clinical pharmacotherapy and improve outcome has application in all phases of the drug development life cycle. Concepts of using pharmacogenomics to guide clinical trials are generally known. The specific application of pharmacogenomics of adverse events (in contrast to genetic identification of high therapeutic responders) includes the post-market surveillance (Phase N) period of the drug life cycle when unexpected adverse events are most likely to arise as well as during early clinical trials. Fundamental to the process of pharmacogenomics has been the establishment of bioinformatics systems designed to maintain, manage and interpret biological data. One drawback in existing systems is a lack of bioinformatics technology to establish a system of databases for individual patients that includes their personal, clinical and genetic data to enable efficient pharmacogenomic therapy. Another drawback in the existing system is a lack of methodologies that provide for establishing individual patient genotypes, including genome wide and candidate gene single nucleotide polymorphisms (SNP's) and detailed adverse drug event information in a unified database to enable the pharmacogenomic therapy.

In addition to metabolic issues, systemic drug adverse events are diverse and have a major impact on the market success of an otherwise successful therapeutic agent. These adverse affects fall under several categories for example: cardiac, liver, central nervous system (including behavior), hematopoetic and metabolic adverse events. A systemic drug adverse event late in the pharmaceutical life cycle (i.e., Phase IV) can be a sudden and limiting factor to a successful product. Therefore, further drawbacks in the existing systems are a lack of bioinformatics system for pharmacogenomic therapy which can utilize systemic drug adverse events.

Pharmacogenomics may also involve the empirical association of numerous relatively low frequency gene variants into a “package” of genetic risk factors which together represent a major tool in the identification of “at risk” populations for a given adverse event. In this way, the small number of patients who might be at risk for even a relatively rare, but medically serious, adverse event might be identified prior to drug administration. This would substantially promote the success of a drug by limiting its adverse affects in its clinical application. However, the existing systems lack bioinformatics features for pharmacogenomic therapy which can analyze low frequency gene variants for adverse drug events.

Pharmacogenetics can be defined as inherited variation in how a drug affects an individual with respect to efficacy and toxicity and how the individual handles the drug with respect to absorption, distribution, metabolism and excretion, based on a single interaction with a gene. The pharmacodynamic response to a drug is dependent upon two major key elements: 1) drug bioactivation (prodrug) and 2) drug target levels.

In order for some drugs to produce a therapeutic response, the drug first needs to be bioactivated. Specific enzymes (proteins) are required to activate the drug. If a SNP is present in this activating enzyme, then the drug will not be activated. For example, clopidogrel is a prodrug that requires bioactivation to elicit its therapeutic benefits. The CYP P450 enzyme system is responsible for the biotransformation that yields the short lived active metabolite that provides the therapeutic benefit of clopidogrel. SNPs inducing loss of function of CYP2C19 enzymes are associated with a decrease in therapeutic response to clopidogrel. Such a decrease in efficacy can result in therapeutic failures. If the expression level of the drug target (site where the drug works) increases or decreases, the dose of the drug will need to be adjusted to improve therapeutic outcomes and reduce toxicity. For example, the anticoagulant warfarin produces its therapeutically beneficial effects by inhibiting the enzyme Vitamin K Epoxide Reductase Complex 1 (VKORC 1). Identifying these SNPs prior to treatment can help prescribers determine the best pharmacologic treatment plan for each individual patient. This will result in achieving therapeutic outcomes more efficiently while minimizing the occurrence of adverse drug reactions (ADRs).

Pharmacokinetics are responses that are determined by how the body handles the drug with respect to absorption, distribution, metabolism and excretion. A SNP in a gene for a metabolizing enzyme can define whether a given patient is a “poor” metabolizer, requiring a lower dose and/or less frequent dosing, or an “extensive” metabolizer, requiring a higher dose and/or more frequent dosing. Knowing an individual's “metabolic characteristics” relative to a particular drug will allow for optimal dosing to achieve therapeutic drug concentrations while avoiding toxicity. ADRs are associated with an inadvertent increase in the plasma drug concentration. Genetic testing can reduce the risk of inadvertently overdosing a patient that is a poor metabolizer. This is achieved by reducing the dosage of the drug to prevent the accumulation of the unmetabolized drug to toxic concentrations in the plasma. Conversely, extensive metabolizers run the risk of rapidly eliminating a drug such that therapeutic levels may not ever be obtained. In these patients, increasing the dosage will improve the likelihood of therapeutic levels being achieved. In other words, the normal dose is simply too high for an individual with a genetic predisposition for decreased drug clearance. For example, subtle differences in the genes for CYP2D6 and CYP2C9 have been associated with ADRs despite normal dosing of the drugs paroxetine and warfarin, respectively. In these cases, the ADR is due to the body's decreased ability to metabolize the drug (compared to normal individuals) can result in elevated plasma concentrations leading to ADRs. The consequences of being a “poor metabolizer” include not only a decrease in the clearance of a drug, but also other alterations in the pharmacokinetics of a drug such as a longer half-life. Not only would a “poor metabolizer” have higher concentration of a drug following administration of a standard dose, but they would also take longer to eliminate the drug from the body. It is the longer half-life with a standard dosing interval that results in drug accumulation to potentially toxic concentrations. Poor metabolizes of drugs would likely need lower doses and less frequent dosing. Less commonly, extensive metabolizes (also resulting from SNPs) will have lower concentrations and a shorter half-life, potentially requiring larger doses that are given more frequently.

In the clinical setting, pharmacists play a major role in monitoring and adjusting doses based on pharmacodynamic and pharmacokinetic data. Pharmacists therefore would be the optimal healthcare providers for leading and managing the implementation of pharmacogenetics in the area of improving therapeutic outcomes and reducing ADRs.

The following describes a system and method for utilizing human genetic and genomic information to guide prescription dispensing and improve drug safety in a pharmacy practice setting. The system and method utilizes a dedicated information management system and software to utilize patient-specific genetic information to screen for increased risk of adverse drug reactions and/or therapeutic or pharmacokinetic responses at the time of drug dispensing under the supervision of a pharmacist.

### SUMMARY OF THE INVENTION

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

It is an aspect of the present invention to provide a system and method for predicting a risk of adverse events and/or therapeutic responses to one or more drugs for a patient comprising a digital apparatus, a patient electronic health record (EHR), a patient genotypic record, a Human Genotypic Database (HGD) module, where the HGD comprises a collection of genotypic information for linkages between known SNPs, at least one data import module and at least one data quality control module, a RISK database module, where the RISK database module comprises a collection of established SNP-risk linkages and detailed information about each risk to determine a link between the genetic information and the adverse drug reaction information for a single or plurality of patients; a drug database comprising pharmacodynamic parameters and pharmacokinetic parameters regarding one or more drugs and an output to a digital apparatus of an analysis of the predicted risk of adverse events or therapeutic response to one or more drugs for said patient based on analysis of said patient's said genotypic record and said EHR with said at least one HGD and said RISK database.

It is another aspect of the present invention to provide a system and method that identifies immediate information about the risk of adverse drug reactions at the time of drug dispensing based on analysis of the patient's genotypic record and EHR with the HGD and the RISK database.

It is another aspect of the present invention to provide a system and method that identifies immediate information about the risk of drug-drug interaction risk at the time of drug dispensing based on analysis of said patient's said genotypic record and said EHR with said at least one HGD and said RISK database.

It is another aspect of the present invention to provide a system and method that identifies immediate information about the risk of drug-gene interaction risk at the time of drug dispensing based on analysis of said patient's said genotypic record and said EHR with said at least one HGD and said RISK database.

It is another aspect of the present invention to provide a system and method that identifies immediate information about the risk of drug-xenobiotic interaction risk at the time of drug dispensing based on analysis of said patient's said genotypic record and said EHR with said at least one HGD and said RISK database.

It is another aspect of the present invention to provide a system and method to notify a user of the digital apparatus increased adverse drug reaction risk based on analysis of a patient's genotypic record and EHR with a HGD and a RISK database.

It is another aspect of the present invention to provide a system and method that suggests alternate drug(s) options to a patient based on a patient's genotypic record and EHR where the genotypic record and EHR harbor genetic evidence for increased risk of an adverse drug reaction to a prescribed drug(s).

It is another aspect of the present invention to provide a system and method of claim 1, wherein said digital apparatus calculates the change in drug clearance and impact on said patient's drug plasma area under the curve (AUC) based on analysis of said patient's said genotypic record and said EHR with said at least one HGD and said RISK database.

It is another aspect of the present invention to provide a system and method that estimates the risk of reaching the minimum toxic concentration in plasma in a patient for a prescribed drug based on analysis of a patient's genotypic record and EHR with a HGD and RISK database.

It is another aspect of the present invention to provide a system and method that identifies if a patient lacks sufficient genomic information in a patient's genotypic record and EHR to predict or assess a risk of adverse drug reactions.

It is another aspect of the present invention to provide a system and method that provides a patient with an immediate genetic screening of a patient's genotypic record and EHR at the time of a prescription being filled.

It is another aspect of the present invention to provide a system and method that prioritizes the need for genetic screening for said patient based on a therapeutic index of a prescribed drug and a drug's overall risk of adverse reactions.

It is another aspect of the present invention to provide a system and method that prioritizes the need for genetic screening for a patient based on the oral bioavailability of a prescribed drug and said drug's overall risk of adverse reactions.

It is another aspect of the present invention to provide a patient with control of the access a user has to the said patient's said genotypic record and said EHR.

It is another aspect of the present invention to provide a results sharing module to allow the user to report any changes to the drug prescribed for said patient.

It is another aspect of the present invention to provide a system and method comprising an automated guidance module for repeated testing of a patient's genotypic record to detect an abnormal state.

It is another aspect of the present invention to provide a system and method where if an abnormal state is detected the present invention suggests altering therapeutic methods.

It is another aspect of the present invention to provide a system and method for periodically reconciling the patient genotypic record and the patient EHR with information in the RISK database to determine if the patient should have additional DNA testing.

It is another aspect of the present invention to provide a system and method that provides guidance on the safest and most effective method of dosing one or more drugs comprising oral dosing, subcutaneous dosing, or intravenous dosing.

In addition to the exemplary aspects and embodiments described above, further aspects and embodiments will become apparent by study of the following descriptions.

### DEFINITIONS

In the description and tables that follow, a number of terms are used. In order to provide a clear and consistent understanding of the specification and claims, including the scope to be given such terms, the following definitions are provided:

Abnormal State. As used herein “Abnormal state” means (1) the patient harbors genetic evidence for an increased risk of an adverse drug reaction (ADR) if the normal dose, dosing method, or drug is administered, (2) the patient has already experienced an ADR and is genetically tested to attempt to prevent subsequent ADRs, and/or (3) the genetic coverage of any prior genetic tests for a patient are insufficient to provide rigorous guidance on a prescribed drug and dosing regimen.

Adverse Drug Reaction (ADR). As used herein “ADR” means an unwanted, negative consequence associated with the use of a given drug. ADRs include toxicities associated with a drug and can result from doses being too high, normal or too low. This includes, but is not limited to an increase in drug levels in the body that lead to an ADR, a decrease in drug levels in the body that lead to an ADR (e.g. under dosing), and/or a decrease in drug levels in the body due to decreased activation of a prodrug that lead to an ADR.

Area under the curve (AUC). As used herein “Area under the curve” means the bioavailability of an active drug in systemic circulation following intravenous or non-intravenous administration. This is obtained usually by a plasma drug concentration vs. time plot for the drug.

Data Import Module. As used herein “Data Import Module” refers to an analysis module within the HGD module that is designed to convert various forms of genetic information to a standard form.

Digital apparatus. As used herein a “Digital apparatus” includes but is not limited to a personal computer, a laptop computer, a handheld computer, a personal digital assistant, a server, a minicomputer, a mainframe computer, a set of clustered servers, a supercomputer, or a device containing a multi-core processor, multiple processors, one or more graphical processing units, a microcontroller, one or more application-specific integrated circuits, or one or more field-programmable gate arrays.

Drug database. As used herein “Drug database” refers to a database containing pharmacodynamic parameters and pharmacokinetic parameters related to one or more drugs.

Drug-drug interaction risk. As used herein “Drug-drug interaction risk” means a situation in which a drug or drug affects the pharmacokinetic or pharmacodynamic response to another drug, in other words. The pharmacodynamic or pharmacodynamic effects of a drug or both drugs are increased or decreased, or they produce a new effect that neither drug produces on its own.

Drug-gene interaction risk. As used herein “Drug-gene interaction risk” means a situation in which a SNP affects the pharmacokinetic or pharmacodynamic response to drug, in other words. The pharmacodynamic or pharmacodynamic effects of a drug are increased or decreased, or a new response is observed.

Drug-xenobiotic interaction risk. As used herein “Drug-xenobiotic interaction risk” means a situation in which a xenobiotic (e.g. foreign substance to the body like herbal products) affects the pharmacokinetic or pharmacodynamic response to a drug, in other words. The pharmacodynamic or pharmacodynamic effects of a drug are increased or decreased, or a new response is observed.

EHR. As used herein “EHR” refers to a patient's electronic health record including but not limited to a patients age, weight, genotypic record, SNP, Amino changes and any history of adverse drug reactions.

Genotypic Record. As used herein “Genotypic record” refers to a patient's genetic database, including but not limited to SNP data.

Oral bioavailability. As used herein “Oral bioavailability” indicates the fractional extent to which a dose of a drug reaches its site of action or a biological fluid from which a drug has access to its site of action. A drug that is administered intravenously has a 100% bioavailability.

Pharmacodynamic. As used herein “Pharmacodynamics” is the study of what a drug does to the human body. Pharmacodynamics is the mechanism of drug action.

Pharmacodynamic parameters. As used herein “Pharmacodynamic parameters” includes but is not limited to a drug's interaction with macromolecular components of the body to yield biochemical or physiological changes that are characteristic of a drugs action. These macromolecules include but are not limited to proteins, receptors, enzymes, gene targets, and ion channels.

Pharmacogenetics. As used herein “Pharmacogenetics” means analysis of the human genetic variation that creates differing responses and interactions to one or more drugs.

Pharmacokinetic. As used herein “Pharmacokinetics” is the study of what the body does to the drug or drugs with regards to the drug or drugs absorption, distribution, metabolism (biotransformation), and elimination.

Pharmacokinetic parameters. As used herein “Pharmacokinetic parameters” includes but is not limited to drug or drugs absorption, bioavailability, route of administration, clearance, volume of distribution, half-life, steady state levels, and dosing.

Pharmacovigilance. As used herein “Pharmacovigilance” relates to the detection, assessment, understanding and prevention of adverse drug reaction, particularly long term and short term adverse drug reactions of medicines.

Prodrug. As used herein “Prodrug” refers to a drug that is inactive until it is biotransformed or bioactivated by an enzymatic or nonenzymatic reaction in the body.

Quality Control Module. As used herein “Quality Control Module” refers to an analysis module within the HGD module that is designed to identify any foreign genetic information that may contaminate a genetic sample that is being analyzed in the HGD module. This includes the identification of contaminating human DNA (i.e. the DNA sample from the patient is contaminated with DNA from one or more different individuals), and/or DNA from non-human sources (i.e. bacterial, viral, canine from a house pet, etc.).

Results sharing module. As used herein a “Results sharing module” is a module on the digital apparatus that allows a user of the apparatus to report any changes or modifications to a prediction by the analysis of the present invention.

SNP. As used herein “SNP” means single nucleotide polymorphisms.

Therapy or Therapeutic. The term “Therapy” or “Therapeutic” refers to a process that is intended to produce a beneficial change in the condition of a, a human, often referred to as a patient. A beneficial change can, for example, include one or more of restoration of function, reduction of symptoms, limitation or retardation of progression of a disease, disorder, or condition or prevention, limitation or retardation of deterioration of a patient's condition, disease or disorder. Such therapy can involve, for example, nutritional modifications, administration of radiation, administration of a drug, behavioral modifications, and combinations of these, among others.

Therapeutic index. As used herein “Therapeutic index” is the concentration range that provides efficacy without adverse drug reactions.

Therapeutic methods. As used herein “Therapeutic methods” includes both pharmacological and non-pharmacologic methods for treating a disease and/or condition.

### BRIEF DESCRIPTION OF THE DRAWINGS

FIG. 1. shows the overall flow of the present invention from when a user uploads a patient's EHR as well as the patient's genotypic record and enters a prescribed drug. This information is compared with a HGD as well as additional scientific, clinical and statistical research and then compared with a RISK database the analysis of which is then provided to the user on the apparatus.

FIG. 2. shows a flow diagram of the development of a patient's genotypic record.

FIG. 3. shows an example of the visual output on the apparatus of the present invention.

FIG. 4. shows and example of the SNP-specific components of a patient's genotypic data, and how it may change using updates that reflect new discoveries from linkage studies.

FIG. 5. shows an example of the SNP-specific risk components of a patient's genotypic data, and how it may change using updates that reflect new discoveries from linkage studies.

FIG. 6. shows where a patient controls outside access to genotypic data based on how the data is used. In this figure, the patient has allowed access to SNP data corresponding to adverse drug response risk, yet prohibited access to SNP data known (or unknown) to be relevant to overall disease and general health risk.

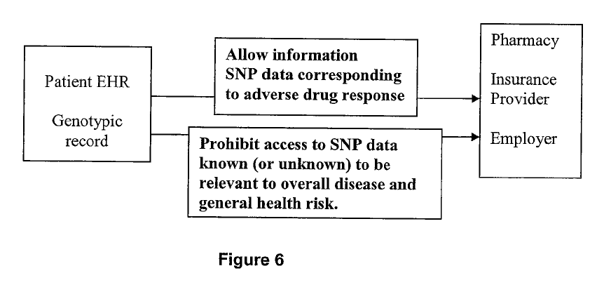

### DESCRIPTION OF THE PREFERRED EMBODIMENT

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

Every year in US clinics over 2 million hospitalized patients (6.7% of all hospitalized patients) experience serious adverse drug reactions, with over 100,000 deaths annually due to these serious reactions. This has positioned serious adverse drug reactions as the 4^{th} leading cause of death in the US. The emerging field of personalized medicine involves the use of clinical genotyping of patients to determine if a specific prescribed drug (or drug dose) is safe for the patient, using patient-specific genetic variations to help predict how the patient will respond to the drug.

The present invention is a system and method for utilizing human genetic and genomic information to guide prescription dispensing and improved drug safety in a pharmacy setting. The system and method of the present invention utilizes a dedicated information management system, software and apparatus to utilize patient-specific genetic information to screen for increased risk to drug reactions and pharmacokinetic therapeutic responses at the time of drug dispensing under the supervision of a pharmacist.

An unexpected advantage of the present invention is the instructional component that provides outline of risks/benefits to DNA sampling (i.e. primarily the “risk” of information abuse using patient-specific genotyping data) as well as a categorical understanding of how DNA can be utilized in healthcare (i.e. drug safety and efficacy assurance, diagnostics, and the identification genomic markers of disease predisposition).

The system and method of the present invention can be run on a variety of computer systems and languages.

### EXAMPLE 1

### Development of the System and Method of the Present Invention

In one example of the present invention Microsoft Corporation's .NET Framework 2.0 and C# programming language were utilized in conjunction with Microsoft Access as a back-end database. A web-enabled production application was also developed using Microsoft's .NET Framework 3.5, C# programming language, Windows Presentation Foundation (WPF) (a development framework for user interfaces and graphics), and Windows Communication Foundation (WCF) (a development framework for web services) with SQL Server 2008 serving as the back-end relational database. The production environment of the present invention was a four (4) node cluster of Sun Microsystems Sun Fire X4100 enterprise-class servers, with each server running Windows Server 2008 Datacenter Edition. The cluster hosts a Microsoft Internet Information Services (IIS) 7.0 web server and a Microsoft SQL Server 2008 database cluster, and the production software employs this clustered infrastructure.

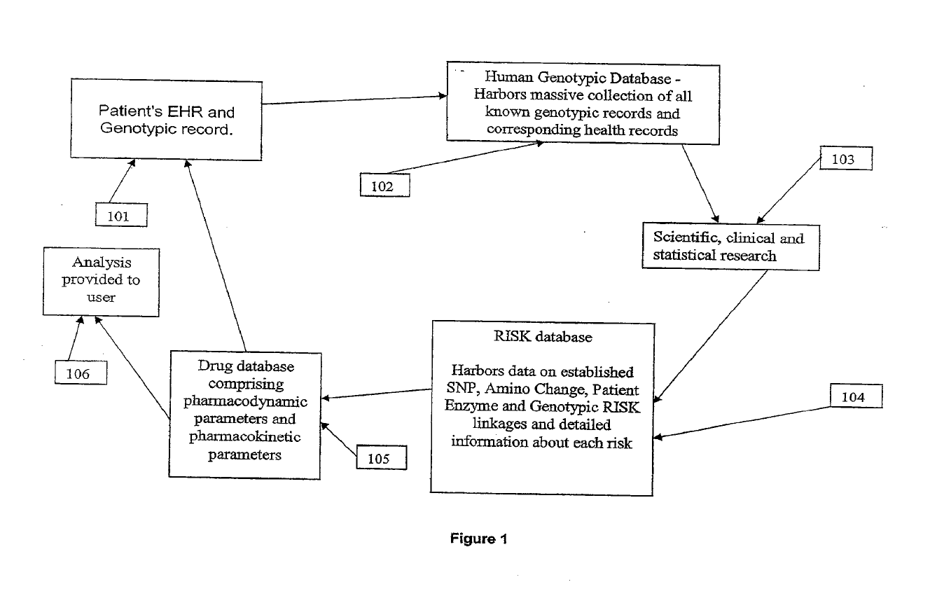

As shown in FIG. 1, the present invention takes a patient's EHR and genotypic record which can be added anonymously to the HGD and compares the data in the patient's EHR with the HGD 101. The user then enters a drug from a known list of drugs or adds a drug into the system. The drug entered and the patient's EHR and genotypic record are the compared with the HGD. The HGB is a massive collection of all known genotypic records and EHRs with the function to provide the system of the present invention with information related to studies to established linkages between known SNPs and clinically relevant phenotypes 102. Additional scientific, clinical and statistical research is also incorporated into the HGD 103. This information is then sent to the RISK module where a database harbors data on established SNP, genotypic risk linkages and detailed information about each disease or risk 104. Analysis of the patient's EHR and genotypic record in comparison with the HGD and analysis with the RISK module is then analyzed in the drug database where the analysis is compared to pharmacodynamic parameters and pharmacokinetic parameters for one or more drugs 105. The analysis is then sent to a digital apparatus where a pharmacist or health care provider is able to review the data from the analysis and determine if a prescribed drug dosage is correct or needs to be modified 106.

### Patient Electronic Health Record (EHR) Management and Utilization.

The utilization of an EHR is a new concept in healthcare. The overall usefulness and impact of genotypic information in the clinic (from both the consumer and healthcare provider perspective) should precede a wide-spread system implementation. This further rationalizes the system described below, where SNPs relevant to drug safety as utilized in the pharmacy (and pharmaceutical industry) represents the ideal introduction of genotypic information in our healthcare system.

### Development of a Patient's Genotypic Record.

The deployment of genotyping technology in the clinic uses results from laboratory tests (regardless of the genetic assay platform) can be effectively managed for the benefit of patients and the general population. Unlike laboratory tests used in the clinic, the results of genotyping tests are stored in a patient-specific database (utilize patient identifier) due to the large number of potential data points (SNPs) from a single test, as well as contribute to population-scale database (anonymous identifier). Clearly, the first application of genotyping technology is aimed at surveying drug metabolism enzymes to identify patients that are deficient in drug metabolism activity, which leverages knowledge that specific SNPs are known to confer this phenotype and testing is limited to these SNPs. The overarching logic to this approach is that a specific SNP is first associated with a clinically-relevant phenotype, and then deployed as a clinical test. Yet the association of known SNPs with clinically-relevant phenotypes can also be determined retrospectively. The population-scale database reflects the growth of both the number of patients (people) contributing genotype database, and the number of SNPs assayed from each person's genome, and ultimately represent a resource linking genetics with public health informatics. In this approach a collection of known SNPs is assayed and stored in a population-scale database, which also includes (anonymous) data from the patient's healthcare record. This provides a resource (database) to discover linkage between specific SNP(s) and clinically-relevant phenotypes, ultimately linking genotypic data to specific phenotypes.

The data captured from clinical genotyping includes patient identification, genotypic data, and other aspects associated with patient-specific sampling, but also accommodate the integration genotypic data not collected in earlier genotyping tests, information about the testing method, quality control data, as well as the emergence of new technologies involved in testing and data management. Finally, the data is integrated with a supporting (dynamic) database system that communicates health risks associated with each genotype. Given that the emergence of disease and drug adversity risk with each genotype may be dependent on other genotypic/phenotypic factors, or may simply not yet be known or fully understood, the conversion of genotypic data to health risk is separate from the patient genotypic data record. The following is a sample list of data that may be used for the genotypic data record;

1) Patient Identifier

2) Sample Source/Tissue

3) Age of Patient at Sampling

4) Genotypic Data

5) Genotyping/Laboratory Method

6) Quality Control Method

7) Ethnicity, Gender and Existing Genetic Considerations

8) Most Recent Date (and Method) of RISK Data integration

In addition to the patient's identifier, data includes the source of the genetic material being tested (#2 shown above). Potential genetic factors may be tissue specific, such as genetic variability associated with oncogenesis (e.g. normal tissue vs. cancerous tissue), which are certainly crucial, if not the motive, for genotyping. In addition, contaminating genetic material (e.g. bacterial, contaminating human genetic material) may be present in skin samples or mucosal secretions may be considered as a component of the quality control methods (#6 shown above), and can be captured in the sample source data. Additionally, the age of the patient is needed for genotypic comparisons made for the patient later in life (#3 above). As mentioned earlier, many methods for genotyping already exist and the emergence of new technologies in this arena is certain. Therefore the method used for a specific data collection/test is captured, as well as the testing laboratory, personnel involved, and any other relevant information about the location and technology employed. The methods employed to insure the sample and the laboratory test was performed correctly contributes to a quality control determination, and utilizes both genomic sequence and assay standards added to the sample under investigation. Knowledge of an existing genetic condition, such as trisomy 21, results in triploid data (rather than the expected diploid data) for all genotypic data derived from genetic material on chromosome 21. Finally, given the proposed paradigm that allows the genotypic record to be updated with new risk information, the date of the most recent comparison between the patient's genotypic record and the risk database is stored (in the patient's record) to insure risk assessment is based on all data available (#8).

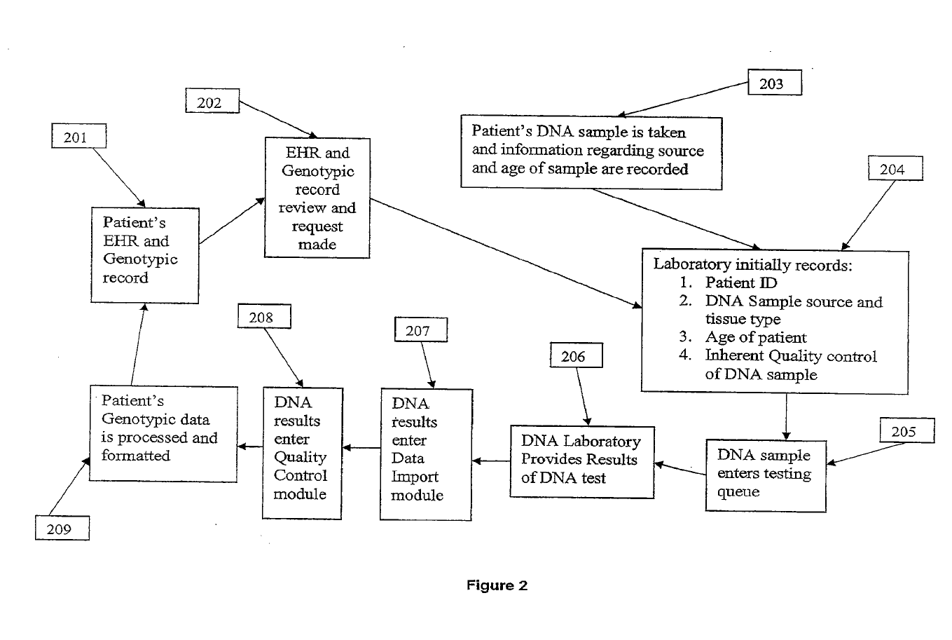

The development of a patient's genotypic record is an important aspect of the present invention. As shown in FIG. 2, 201, a user inputs into the present invention the patient name and ID number into the apparatus of the present invention. The present invention analyzes the current information regarding the patient EHR and genotypic record and the present invention determines if there is enough information in the patient's genotypic record to perform an analysis as to any increased risk to drug reactions and pharmacokinetic therapeutic responses at the time of drug dispensing. If the present invention determines that there is not enough genotypic information a request is made for a sample of the patient's DNA to be analyzed 202. A sample of the patient's DNA is then taken and information regarding the source of the DNA and age of the sample are recorded 203. The laboratory then also records additional information regarding the patient and the DNA sample including the patients ID number, age, source and tissue type of DNA sample and any inherent quality control methods that are to the used in the testing of the sample 204. The DNA sample then enters the sampling queue 205. The laboratory will then provides the results of the DNA test results 206. The test results then enter the Data Import module, where as will be explained later the data is compared with other genotypic records of the patient and any conversions are made to integrate the new data with previously recorded data 207. The DNA results then enter the Quality Control module, where as will be discussed later, the DNA results are analyzed to ensure that no extraneous or foreign DNA contaminated the results 208. The patient's genotypic data is then formatted, processed and entered into the patient's genotypic record 209.

### Development of Human Genotypic Database

In another aspect of the present invention is the use of a human genotypic database (HGD) as shown in FIG. 2. The HGD was derived from large numbers of people and patients establishing new genetic links to health risk. A large cohort of patients is genotyped acrossed thousands of known single nucleotide polymorphisms (SNPs) that include SNPs that have established links to the risk of adverse drug responses and disease, as well as SNPs that currently have no known association with human health outcomes. The discovery of one or more SNPs associated with a specific phenotype or disease risk uses a large Human Genotypic Database (HGD) derived from individual genotypic records, which includes other aspects of their health records. For example, the discovery of SNPs that are linked with cardiovascular disease involves a statistical comparison of SNPs between a large group of patients experiencing cardiovascular disease and a large control (disease free) group. In practice, this involves the derivation of a HGD where the patient identifiers have been removed (achieving privacy through anonymity) that include both genotypic and overall health information for each person, which is a natural artifact of utilizing the hierarchy described in Table 1.

Some resources available to aid in the development of the Human Genotypic Database include:

United States Food and Drug Agency Orange Book: For Drug information Center for Drug Evaluation and Research. (2008, Dec. 22). Approved Drug Products with Therapeutic Evaluations: Orange Book.

Goodman and Gilman's The Pharmacological Basis of Therapeutics: For Drug pharmacokinetic data, drug metabolic equations and formulae L. L. Brunton, J. S. Lazo, & K. L. Parker, Goodman & Gilman's The Pharmacological Basis of Therapeutics. New York: McGraw-Hill.

National Center for Biotechnology Information: PubMed

National Center for Biotechnology Information: Genbank

PharmGKB: The Pharmacogenetics and Pharmacogenomics Knowledge Base: T. E. Klein, J. T. Chang, M. K. Cho, K. L. Easton, R. Fergerson, M. Hewett, Z. Lin, Y. Liu, S. Liu, D. E. Oliver, D. L. Rubin, F. Shafa, J. M. Stuart and R. B. Altman, “Integrating Genotype and Phenotype Information: An Overview of the PharmGKB Project,” The Pharmacogenomics Journal (2001) 1, 167-170.

National Center for Biotechnology Information: Single Nucleotide Polymorphism

### Genotypic Data Standards and Data Sources

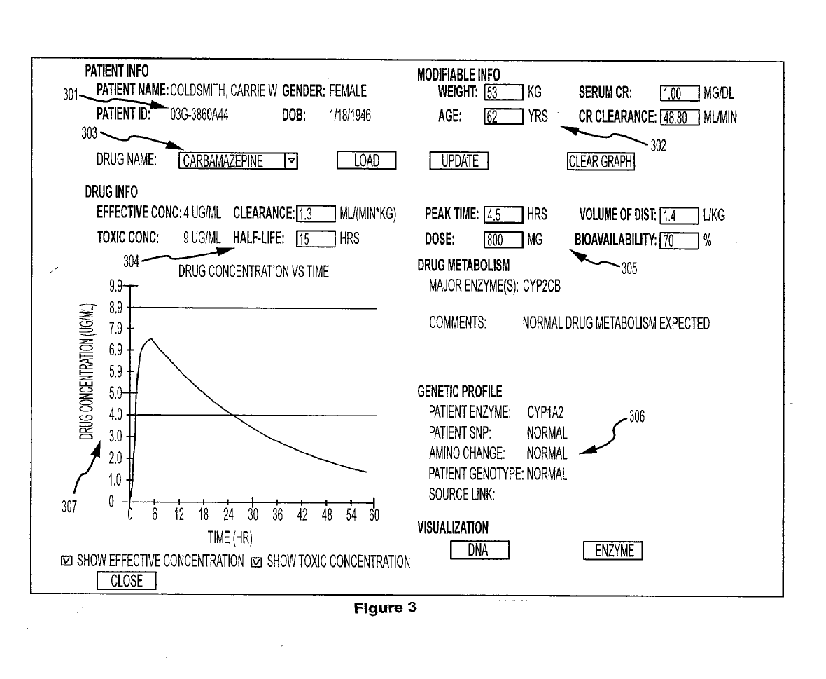

The data relevant to a patient's genotype includes nucleotide base identification and zygosity at each SNP position, and could include flanking genomic sequence information (depending upon the technology employed). For example, using DNA microarray technology for genotypic screening is be essentially limited to homozygous or heterozygous data for a given SNP position, while genotypic data derived from direct DNA sequencing provides potentially hundreds of bases of DNA flanking one or more SNPs, which represents a large string of DNA sequence that can be captured. The genotypic data capture is recognized within the context of the technology or method utilized, and the method or technology utilized is identified within the genotypic data record (see FIG. 3). This is not meant to infer that any given method is more sensitive or specific, but rather that results are sometimes technology or method dependent. This is somewhat analogous to the utilization of positron emission tomography (PET) and magnetic resonance imaging (MRI), where results from both tests provide similar insight into the phenotype (phenomena), yet the actual laboratory results are derived from distinct methods. In the case of DNA sequencing, or genotypic data derived from more data rich sources, the DNA sequence data is pared down to the SNP(s) that are present (maintained) in the database of risk linkages. Thus the method of genotyping includes both a categorical description of the biotechnology component (in this case, capillary electrophoresis) and a raw data analysis component (conversion of fluorescent-specific peaks to DNA sequence, and elimination of DNA sequence that does not constitute SNP data). Instances where a given patient harbors a rare genetic condition that is not amenable to SNP-level data is considered as additional information of the patient, and not a component of a system wide genotypic data record format.

### Genotypic Information System

The general architecture of the clinical genotyping information system is represented in FIG. 1. The process of DNA testing is described in FIG. 2, ultimately deriving or updating patient-specific genotypic data. Once the patient's record has been updated, the data is available for contribution to the Human Genotypic Database (HGD). As mentioned earlier, the HGD represents a source for human genetic research capable of establishing new levels of risk to all known SNPs. In addition, once the patient's record has been updated the system accesses the RISK database to determine if the patient's updated SNP profile includes specific genotypes associated with a known health risk. Some level of overall health risk is established, which likely includes categorical classifiers such as either “common” (benign or unknown risk), “drug” (adverse drug risk) or “health concern” (some level of overall health risk). These categorical definitions of risk likely have a simple quantitative component (e.g. low, moderate or high risk) that are used by the clinical system to flag the attention of healthcare workers and other system components.

Many factors influence if and how people derive their genotypic information including: genotyping test costs, privacy and ethics, as well as the overall cost-benefit of genotyping information. The cost-benefit of genotypic information is dependent upon the rigor of predicting clinically-relevant phenotypic traits based on SNP data. Definitive genetic testing may be tenuous given that every nucleotide in the genome is (theoretically) subject to variance, yet the current strategies for genetic testing are limited to testing for the most common mutations that are known to confer a health risk. For example, there are over 900 mutations in the human genome shown to cause cystic fibrosis (CF), yet most genetic testing laboratories limit their testing to the 6 most common mutations, and have predictive success rate of 90% in Caucasians (Gregg, 2002). Using current genetic testing systems, it is not feasible to test for all known mutations that cause CF given (1) the benefit of predicting or diagnosing CF from a genetic test does not justify the costs associated with testing hundreds of known mutations from a patient's sample, and (2) that there is a chance that a (rare) specific polymorphism, which has not yet been characterized, can cause CF and would not be detected in a large-scale genetic testing screen. It can be expected that any genotyping strategy is sensitive to false-negative results given that rare SNPs that are not tested under a given genotyping screen may confer a health risk phenotype.

Deriving sufficient patient information for a large-scale clinical genotyping system initially involves a large population of patients with mature health care records that contain information regarding age-related conditions and diseases, where patient specific genomic information can be added upon sampling/testing. Ideally, a near-term implementation of clinical genotyping involves the addition of patient-specific genomic data to an existing healthcare information management system. Certainly there are many established healthcare groups and systems that are well positioned to benefit from the proposed near-term clinical genomics systems, and partnering with one or more of these groups will both (1) leverage the data and resources inherent to that system and (2) reduce implementation costs by reducing system redundancies. For example, the Veterans Administration (V A) hospital's health care information management system allows for patients to be screened for drug-drug interactions, patient allergies, past medical history etc. Incorporation of the genomic data base into this type of healthcare information management system would allow pharmacists point of care access to genetic information that is beneficial in making therapeutic decisions. The VA system further has a limited drug formulary and a captive patient population that lends itself well to beta-testing the clinical genomic system. By starting with a small population, we can then move to the large-scale clinical genomic system to be implemented not only in hospitals but other pharmacy practice settings. In conclusion, the implementation of a drug safety program that utilizes genomic data to improve patient care and safety while at the same time facilitating the movement of clinical genotyping from bench to bedside will improve general healthcare outcomes.

The operation of the pharmacogenetics prescription (PGRx) system involves the entry or acquisition of a patient's name and/or identifier, and the identification and dose of the prescribed medication. The PGRx system accesses a dedicated database of patient-specific records to determine if the patient harbors genetic evidence of altered drug metabolism capabilities compared to the normal patient population.

### Data Import Module

As shown in FIG. 2, 207 analysis of how the body handles the drug with respect to absorption, distribution, metabolism and excretion is another important aspect of the present invention. A SNP in a gene for a metabolizing enzyme can define whether a given patient is a “poor” metabolizer, requiring a lower dose and/or less frequent dosing, or an “extensive” metabolizer, requiring a higher dose and/or more frequent dosing. Knowing an individual's “metabolic characteristics” relative to a particular drug allows for optimal dosing to achieve therapeutic drug concentrations while avoiding toxicity. ADRs are associated with an inadvertent increase in the plasma drug concentration. Genetic testing can reduce the risk of inadvertently overdosing a patient that is a poor metabolizer. This is achieved by reducing the dosage of the drug to prevent the accumulation of the unmetabolized drug to toxic concentrations in the plasma. Conversely, extensive metabolizers run the risk of rapidly eliminating a drug such that therapeutic levels may not ever be obtained. In these patients, increasing the dosage improves the likelihood of therapeutic levels being achieved. In other words, the normal dose is simply too high for an individual with a genetic predisposition for decreased drug clearance. For example, subtle differences in the genes for CYP2D6 and CYP2C9 have been associated with ADRs despite normal dosing of the drugs paroxetine and warfarin, respectively. In these cases, the ADR is due to the body's decreased ability to metabolize the drug (compared to normal individuals) can result in elevated plasma concentrations leading to ADRs. The consequences of being a “poor metabolizer” include not only a decrease in the clearance of a drug, but also other alterations in the pharmacokinetics of a drug such as a longer half-life. Not only would a “poor metabolizer” have higher concentration of a drug following administration of a standard dose, but they would also take longer to eliminate the drug from the body. It is the longer half-life with a standard dosing interval that results in drug accumulation to potentially toxic concentrations. Poor metabolizers of drugs would likely need lower doses and less frequent dosing. Less commonly, extensive metabolizers (also resulting from SNPs) have lower concentrations and a shorter half-life, potentially requiring larger doses that are given more frequently.

The decision support system that utilizes patient-specific genotyping data requires the ability to import many different data formats 207, and from different DNA detection and DNA screening technologies. This module accepts raw data, as well as partially formatted data, from different DNA screening technologies and CONVERTS this data into a more standardized format that provides the user-interface component with a “layered” hierarchy of information. The user has immediate access to clinically relevant data, which has been provided by the module that provides information about the influence of any SNP data on drug safety and/or drug efficacy (this data is not inherent to raw-data level results from DNA detection). The user has the ability to “drill down” to lower layers of the data to identify the DNA technology(s) utilized in the genotyping screen, as well as all other meta data related to this DNA sampling (dates, methods, clinician, etc), DNA screening (dates, methods, technician, etc), and (if needed) access to the raw data itself.

### Quality Control (QC) Module

The QC module as shown in FIG. 2, 208 provides decision support regarding the quality of results from the screen on the output apparatus as shown in FIG. 1. This can be automated or simply provide the user guidance on any need for retesting the sample. The QC module serves two basic functions:

To provide the clinical healthcare professional with information regarding the quality of the DNA test results, which is particularly important if the DNA screening technology/methods are automated (i.e. lack laboratory technician oversight). This module can support recommendations about the limits of results from each testing biotechnology and provide guidance (a) if the sample needs to be retested, (b) if the retesting should involve a more rigorous testing methodology or technology, (c) and/or if the retesting should be focused on a specific type of SNP or other clinically relevant allelic variation.

To provide the clinical healthcare professional with information regarding the quality of the DNA sample derived from the patient. This includes an analysis of specific testing results that suggest the DNA sample was:

(a) degraded and therefore unacceptable for analysis;

(b) was contaminated my other DNA samples and provides allelic variation that is inconsistent with the diploid nature of humans (i.e. an allelic variation that has 3 or more possible variations in nature is found to have 3 or more results—which could be caused by a DNA sample that contains 2 or more different DNA samples from different people), and

(c) utilizes some prior knowledge about the patient's genetics to insure that the sample results are from that patient, and not another individual, possibly due to sample mix ups or other factors.

### RISK Database

In another aspect of the present invention the data compiled in the Human Genotype Database is incorporated into a RISK database in order to determine health “risk” data, which is the known risk associated with each SNP position, into a patient's genotypic record should temporary and periodically updated to reflect new discoveries and linkages. This dynamic component to the electronic health record reflects the fact that future discoveries may link known SNPs to one (or more) health outcomes, and in the absence of an updatable risk component a patient's genotypic record becomes outdated and thus underutilized. For example, a patient may have data on a specific genotype (SNP or set of SNPs, in a specific genomic location) that, to date has been considered benign and represents no known risk, yet new research findings have determined that the SNP constitutes some level of health risk. Therefore, the most recent date and method by which an individual patient genotypic record has been updated to insure (1) that the most timely genotypic risk and population frequency data has been incorporated into the record and (2) insure that outdated genotypic records are updated (this assumes an application automatically updates the record, and utilizes a time/date stamp to manage updates) (FIG. 2). This notion is easily handled by the database in the information system.

Clearly the management of a genotypic RISK database becomes useful as the central source for determining SNP-specific risk is managed separately and subject to scientific and regulatory oversight. This genotypic risk database includes all known SNPs, and their known frequency within the population in the human genome along with all known health risk information associated with each SNP.

### Output of Analysis to Apparatus

The output of the present invention to the digital apparatus is shown in FIG. 3. A pharmacist or other health provider, using a digital apparatus such as a CPU or PDA, inputs into the apparatus information regarding a Patient's Name and Identification Number, 301. Information from the Patient's EHR including gender, date of birth, weight and age is then automatically uploaded through the internet, 302. The pharmacist or other health care provider then enters into the system a drug name 303. The patient's EHR and genotype are then compared with the HGD 306. The patient's EHR and genotype and the drug entered into the apparatus by the pharmacist or health care provider is then analyzed in the RISK module of the present invention to determine if there is a potential of an adverse drug reaction. Base on the patient's EHR, genotypic data and RISK analysis an effective drug dosage is prescribed by the system of the present invention 304. The present invention also provides an analysis of the effective concentration of the drug, toxic concentration, clearance, drug half-life, peak time of the drug, volume of distance and bioavailability percentage 304. The expected drug metabolism is also analyzed based on the Patient's EHR, genotypic data and comparison with the HGD 305. A results sharing function can also be applied to the present invention to allow a user to report any additional information regarding the patient or the drug back to the prescribing physician. Finally the system of the present invention provides a graph showing the drug concentration overtime in relation to the effective concentration of the drug and the toxic concentration of the drug 307.

Based on the analysis of the patient's EHR, genotypic record with the HGD and the RISK module the present invention also provides to the output screen on the digital apparatus an analysis related to the sufficiency of the patient's genotypic record 306. Based on the analysis of the present invention the output screen shows: 1. the patient has sufficient genetic information on record that indicates there is NO risk above the NORMAL patient population for an adverse drug reaction based on altered drug metabolism capabilities, for the prescribed drug to be dispensed; 2. the patient has sufficient genetic information on record that indicates there is a risk above the normal patient population for an adverse drug reaction based on DECREASED drug metabolism capabilities, for the prescribed drug to be dispensed. The dosing regimen should be adjusted to accommodate the decreased metabolic capabilities of the patient by decreasing the amount and/frequency of the drug dosing regimen, OR an alternate drug should be considered, which can be suggested by the PGRx system based on the patient's genomic data; 3. the patient has sufficient genetic information on record that indicates there is a risk above the normal patient population for an adverse drug reaction based on INCREASED drug metabolism capabilities, for the prescribed drug to be dispensed. The dosing regimen should be adjusted to accommodate the increased metabolic capabilities of the patient by increasing the amount and/frequency of the drug dosing regimen, OR an alternate drug should be considered, which can be suggested by the PGRx system based on the patient's genomic data; or 4. the patient does NOT have genetic information on record relevant to predicting altered drug metabolism, and therefore should undergo a genetic test to derive this information, be monitored closely for evidence of an adverse drug response, or provide some other guidance on counseling the patient, based on the prescribed drug to be dispensed.

### SNP-Specific Risk Analysis and the Use of New Discoveries

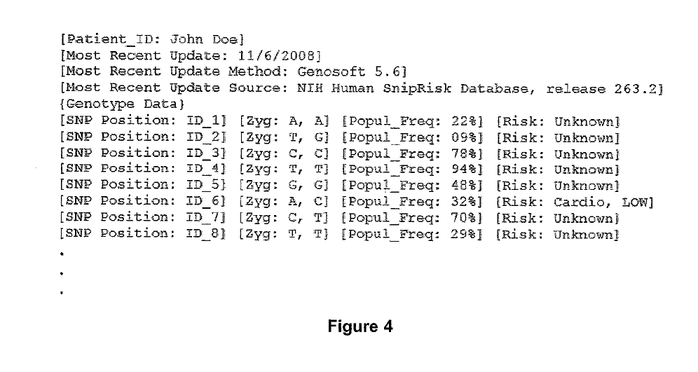

An example of an internal analysis of a SNP-specific risk of a patient's genotypic data is shown in FIG. 4. As shown in FIG. 4, the system of the present invention used the patient ID with an EHR and genotypic database that was updated on Nov. 6, 2008. The patient's information is analyzed by the present invention as well as with the NIH Human SnipRisk Database. As shown in SNP Position:ID 6 analyses showed a low cardio risk. This information is then sent to the output screen on the apparatus for the user to view.

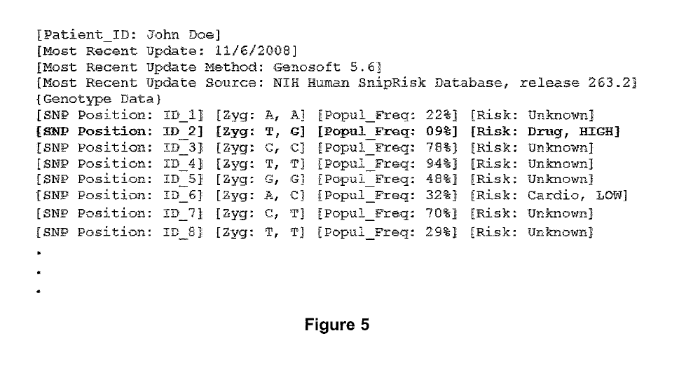

An example of an internal analysis of a SNP-specific where new discoveries from linkage studies has been incorporated into the analysis. As shown in FIG. 5, the system of the present invention used the patient ID with an EHR and genotypic database that was updated on Nov. 6, 2008. The patient's information is analyzed by the present invention as well as with the NIH Human SnipRisk Database but in this example a new drug with a high risk of an adverse drug reaction was detected based upon updates that reflect new discoveries from linkage studies.

### Pharmacokinetic Response

In another aspect of the present invention, data from the HGD is sent to the RISK analysis module to determine the pharmacokinetic response. Pharmacokinetic responses are determined by how the body handles the drug with respect to absorption, distribution, metabolism and excretion. The module looks at data from the HGD such as a SNP sample in a gene for a metabolizing enzyme which can define whether a given patient is a “poor” metabolizer, requiring a lower dose and/or less frequent dosing, or an “extensive” metabolizer, requiring a higher dose and/or more frequent dosing. Knowing an individual's “metabolic characteristics” relative to a particular drug allows for optimal dosing to achieve therapeutic drug concentrations while avoiding toxicity. ADRs are associated with an inadvertent increase in the plasma drug concentration. Genetic testing can reduce the risk of inadvertently overdosing a patient that is a poor metabolizer. This is achieved by reducing the dosage of the drug to prevent the accumulation of the unmetabolized drug to toxic concentrations in the plasma. Conversely, extensive metabolizers run the risk of rapidly eliminating a drug such that therapeutic levels may not ever be obtained. In these patients, increasing the dosage improves the likelihood of therapeutic levels being achieved. In other words, the normal dose is simply too high for an individual with a genetic predisposition for decreased drug clearance. For example, subtle differences in the genes for CYP2D6 and CYP2C9 have been associated with ADRs despite normal dosing of the drugs paroxetine and warfarin, respectively. In these cases, the ADR is due to the body's decreased ability to metabolize the drug (compared to normal individuals) can result in elevated plasma concentrations leading to ADRs. The consequences of being a “poor metabolizer” include not only a decrease in the clearance of a drug, but also other alterations in the pharmacokinetics of a drug such as a longer half-life. Not only would a “poor metabolizer” have higher concentration of a drug following administration of a standard dose, but they would also take longer to eliminate the drug from the body. It is the longer half-life with a standard dosing interval that results in drug accumulation to potentially toxic concentrations. Poor metabolizers of drugs would likely need lower doses and less frequent dosing. Less commonly, extensive metabolizers (also resulting from SNPs) have lower concentrations and a shorter half-life, potentially requiring larger doses that are given more frequently.

### Mobile and Hand-Held Digital Devices

In another aspect of the present invention the output screen on the apparatus from the system and method can be deployed and utilized on a hand-held or mobile digital device, such as a Personal Digital Assistant, a laptop computer or cell phone to allow clinical support to be carried out more flexibly within and beyond the clinical setting. This may or may not involve uploading of patient-specific data through wireless technologies, and all other aspects of the system apply.

### Additional Examples of Various Embodiments of the Present Invention

### EXAMPLE 2

It is another aspect of the present invention to provide a system and method that provides genetic screening for a patient at the time of prescription filling. The user is able to review the analysis provided by the apparatus and determine if additional genetic information is needed from the patient.

### EXAMPLE 3

It is another aspect of the system and method of the present invention where analysis of a patient's EHR and genotypic record is immediately conducted and compared with the HGD and RISK modules. The present invention is then able to immediately identify and provide to the user immediate information about the risk of adverse drug reactions and/or pharmacokinetic therapeutic responses to a drug at the time of drug dispensing based on patient-specific genomic information.

### EXAMPLE 4

It is another aspect of the system and method of the present invention where analysis of a patient's EHR and genotypic record is immediately conducted and compared with the HGD and RISK modules. The present invention is able to identify immediately information about the risk of drug-drug interaction risk at the time of drug dispensing based on patient-specific genomic information.

### EXAMPLE 5

It is another aspect of the system and method of the present invention where analysis of a patient's EHR and genotypic record is conducted and compared with the HGD and RISK modules. The present invention is then able to immediately identify if a patient's EHR or genotypic record that lacks sufficient genomic information to predict or assess the risk of adverse drug reactions or therapeutic responses.

### EXAMPLE 6

It is another aspect of the system and method of the present invention where analysis of a patient's EHR and genotypic record is conducted with the HGD and RISK modules and shows that a patient harbors genetic evidence for increased risk to a specific drug of an adverse drug reaction or a decreased therapeutic response. The present invention is then able to suggest alternate drug(s) options for a patient that harbor genetic evidence for increased risk of an adverse drug reaction based on the prescribed drug(s).

### EXAMPLE 7

It is another aspect of the system and method of the present invention where analysis of a patient's EHR and genotypic record is conducted with the HGD and RISK modules and shows an impact in a patient's drug plasma area under the curve (AUC). The present invention is then able to immediately calculate a change in drug clearance and impact on the patient's drug plasma area under the curve (AUC) based on patient-specific genomic data.

### EXAMPLE 8

It is another aspect of the system and method of the present invention where the present invention is able to estimate the risk of reaching the minimum toxic concentration in plasma in a patient for a prescribed drug based on patient-specific genomic data. Based upon this estimate, the user is then able to determine if the prescribed drug and/ dosage of the drug needs to be modified to avoid the risk of reaching the minimum concentration.

### EXAMPLE 9

It is another aspect of the system and method of the present invention where the present invention is able to prioritize the need for genetic screening for a patient based on the therapeutic index of a prescribed drug and other factors that define a specific drug's overall risk of adverse reactions. For example, a drug that has a low therapeutic index would have a higher need for genetic screening to predict the risk of adverse drug responses in patients.

### EXAMPLE 10

It is another aspect of the system and method of the present invention where the present invention is able to prioritize the need for genetic screening for a patient based on the oral bioavailability of the prescribed drug and the drug's overall risk of adverse reactions. For example, a drug that has a low bioavailability would have a higher need for genetic screening to predict the risk of adverse drug responses in patients.

### EXAMPLE 11

It is another aspect of the present invention where analysis of a patient's EHR and genotypic record is conducted and analyzed with the HGD and RISK modules. The analysis of the patient's EHR and genotypic record shows that a patient harbors genetic evidence for increased risk to a specific drug of an adverse drug reaction or a decreased therapeutic response. Based on the analysis the system and method of the present invention is able to immediately provide limiting or altering dosing regimens for a patient is provided for the user to view on the output screen of the apparatus, based on the patient's genomic data.

### EXAMPLE 12

It is another aspect of the present invention where based on the analysis of a patient's EHR and genotypic with the HGD and RISK module the system and method of the present invention is able to determine that an increase in the frequency of organ-specific toxicity screening (e.g. hepatic toxicity) is required. The user is then able to modify the patient's organ-specific toxicity screening schedule as needed.

### EXAMPLE 13

Another aspect of the present invention is to provide a means form increasing the pharmacovigilance of short-term and long-term drug safety issues. Pharmacovigilance is the detection, assessment, understanding and prevention of adverse effects, particularly long term and short term side effects of medicines. The present invention provides a system and method for enabling pharmacovigilance where short-term and long-term drug safety issues and outcomes are predicted, and/or more frequently or exhaustively monitored, and/or identified to be independent of patient-specific drug metabolism capabilities identified through genomic screening.

### EXAMPLE 14

### Patient-Controlled Access

It is another aspect of the present invention where a patient has control of the access a user has to a patient's genotypic record and EHR. The ethical concerns to genotyping in a clinic, which are also applicable to electronic health records in general, are essentially privacy and security. The benefits of incorporating genotyping (genetic information) in therapeutics and medicine are questioned when the risk of ‘information abuse’ is considered. For example, a patient may be unwilling to utilize the benefits of genotyping if they fear that their employer and/or insurance provider can utilize the same information to (accurately or inaccurately) predict the patient's future health status. This dilemma involves both societal and genetic components. At the genetic level, the validity of extrapolative health assessment based solely on genotypic data has not been broadly established, and is limited to a few known\genetic diseases. Therefore any long-term claims to health status for the majority of the population would be invalid at this point in time. Yet, it should be noted that the risk of adverse drug response based on known SNPs in drug metabolism enzymes has been established (see table 2), and represents the near-term benefit to clinical genotyping.

Furthermore, note that the use of the term SNP (single nucleotide polymorphism) herein includes nucleotide base substitutions and single base deletions/substitutions within the human genome. In addition, knowledge of this predisposition does not represent association with other health risks. Thus knowledge of the risk of adverse drug response is a benefit to the patient, employer and insurance provider since overall healthcare costs would be minimized by avoiding adverse drug reactions. Allowing the patient to control external access to their genotypic data within this categorical distinction (e.g. “adverse drug response risk” data access=yes; “general health risk” data access=no) positively contributes to the adoption and success of genotyping in the clinic.

### EXAMPLE 15

### Sharing Results Between the Prescribing Physician and the Drug Dispensing Pharmacist

Another aspect of the present invention provides a system and method that includes a results sharing module on the apparatus of the present invention that includes an option for the user to share specific results of the prediction of an (a) adverse drug reaction risk, and/or (b) ineffective dosing option or drug choice. This module on the apparatus can be used in either a secured, digital interchange between these groups (doctor and pharmacist), or in a non-secured interchange where patient identifiers have been removed or replaced. In a simple example of this module's function, the pharmacist utilizes the system to identify a patient at risk of an adverse drug reaction (i.e. the system has integrated the patient's genotypic information with the prescribed drug/dose), then faxes a report demonstrating this evidence for this conclusion to the prescribing physician. The fax lacks all patient identifiers, and is simply markers with an alpha numerical identifier. The pharmacists and the physician (or other authorized representative such as nurse practitioner) share a short phone call to discuss altering the prescription to reduce the risk of an adverse drug reaction, verbally citing the alpha numerical identifier to identify the patient during the conversation.

### EXAMPLE 16

### Automated Guidance for an Abnormal State

It is another aspect of the present invention to provide a system and method provides automated guidance for repeated testing for clinical genotyping in patients. If an “abnormal” state” is detected in a patient's genotypic profile that suggests altering therapeutic methods to accommodate this situation, the system may suggest to repeat the genetic testing, and possibly suggest an alternate method of genetic testing based on the results and techniques used in the initial or earlier genetic testing methods. Similarly, if the results of the genotyping method for a patient harbor documented or inferred evidence of poor-quality testing (regardless of the patient's genotypic profile or normal/abnormal state), the system can suggest to repeat the genetic testing, and possibly suggest an alternate method of genetic testing based on the results and techniques used in the initial or earlier genetic testing methods. The system can also provide short-term guidance on therapeutic options for the patient as the patient awaits genetic testing results, either from an initial request for testing or during a retesting of the genotypic profile.

Abnormal state can be defined in general terms as (1) the patient harbors genetic evidence for an increased risk of an adverse drug reaction (ADR) if the normal dose, dosing method, or drug is administered, (2) the patient has already experienced an ADR and is genetically tested to attempt to prevent subsequent ADRs, and/or (3) the genetic coverage of any prior genetic tests for a patient are insufficient to provide rigorous guidance on a prescribed drug and dosing regimen.

### EXAMPLE 17

The system and method of the present invention that provides a module for periodically (or triggered by changes in data) reconciling patient genotype data in the EHR with information in the RISK database to determine if the patient should have additional DNA testing carried out to achieve a complete (or up-to-date) genotype dataset in their EHR. This method is predicated on the fact that new discoveries continuously drive (increase) the information in the RISK dataset (e.g. in 2010 there are 200 SNPs in the RISK db, in 2011 there are 800, and so on), and inevitably there will be data about the risk of certain SNPs and/or allelic variations that have not yet been tested in a subset of patients. This module identifies patients that are recommended for addition DNA screening tests if new data exists (and is absent in their EHR), and/or new screening methods/tests become available. This can occur at predetermined periods (e.g. annually), and/or when new RISK data has been added/detected/released, and/or if the patient has a specific health risk/issues and should be tested when new information relevant to his/her health risk become available.

### EXAMPLE 18

The system and method of the present invention provides guidance on the safest and/or most effective method of dosing the drug including, but not limited to oral dosing, subcutaneous dosing, and/or intravenous dosing.

### Further Embodiments of the Present Invention

The use of an N-series prefix for an element number (NXX) refers to an element that is the same as the non-prefixed element (XX), except as shown and described thereafter. Although various specific quantities (spatial dimensions, temperatures, pressures, times, force, resistance, current, voltage, concentrations, etc.) may be stated herein, such specific quantities are presented as examples only, and are not to be construed as limiting.

The utilization of a patient's genetic data to aid diagnostic and prognostic healthcare represents the ultimate achievement of 50 years of genomic research. The technology to recognize this vision has emerged, and continues to evolve. In the future, patient-specific genomic data is derived before birth and include an exhaustive sampling of genomic information. This genetic data is periodically updated throughout a patient's lifetime on a tissue-specific basis in order to screen for genetic changes conferring age-related diseases. The patient's genotypic data is further be integrated with dedicated databases/warehouses harboring genetically-linked health and adverse drug response risk that is utilized at the point-of-care for patient-specific therapeutic interventions. Yet, the path to this future in genomic-based healthcare is obscured by several independent factors that are recognized and overcome to fully exploit genomic content in human healthcare. The following are categorical hindrances to a societal-scale implementation of clinical genomics:

1) High-Throughput DNA Analysis Technology: Costs, Data Standards and Future Technologies.

2) Information Management: Access, Security and System Structures.

3) Genomics & Genetics Education: Physicians, Pharmacists, Nurses and Consumers.

4) Point-of-Care Utilization of Genomics: Physician's Office, Hospital, Pharmacy and Consumer.

5) Capitalism & Pharmaceuticals: Risks and Returns on Investment in Genomic based Laboratories and Information Systems.

6) Electronic Health Record Management and Utilization.

7) Translational Research: Establishing Linkages Between Allelic Information and Healthcare Outcomes.

### High-Throughput DNA Analysis Technology: Costs, Data Standards and Future Technologies.

Certainly there are numerous analytical methods for DNA analysis that support both SNP (single nucleotide polymorphisms) discovery and SNP detection (SNP discovery and detection represent distinct analytical challenges that are not described in this manuscript), and competition within the biotechnology industry continues to advance these capabilities from all relevant perspectives (cost, throughput, data quality, ease-of-use, etc.). Yet at the heart of a large-scale clinical genomics implementation is an information management system that can accommodate many different analysis methods (including new biotechnologies that emerge in the future) through the development of a group of scalable data standards for genomic information. Although significant advances in biotechnology are occurring, the data standards for sharing genomic data precede genotyping in the clinic.

### Information Management: Access, Security and System Structures.

Included in this manuscript is the rationale for an information system that categorically separates SNP data relevant to drug safety from SNP data relevant to general health outcomes. By categorically separating SNPs relevant to drug safety from SNPs linked to other health outcomes and SNPs with no known linkages (it is recognized that there is some small overlap in this distinction), consumers can: (1) understand how their own genomic data is being utilized and gain trust in these systems, (2) indicate how their own genomic data is managed and who can gain access to these categorical data sets, and (3) provide a rationale for security that is dependent upon the category of the data. For example, drug safety data may be more easily accessed by worldwide healthcare institutions and pharmacies since these data may be needed in an emergency for an injured traveler. In contrast, other SNP categories are stored much more securely and are NOT shared across institutions. This concept assumes that consumers are (1) able to control access to their genotypic information and (2) SNPs inherent to drug safety are far less likely to serve (or be abused) as indicators of general health for an individual.

### Genomics & Genetics Education: Physicians, Pharmacists, Nurses and Consumers.

Given the very recent advances in human genomic knowledge and biotechnology methods, it is not feasible to assume that physicians, pharmacists, nurses, and other professionals within the healthcare industry harbor sufficient knowledge to translate raw genomic data to information relevant to health outcomes. First, most all genomic data are filtered into categorical definitions and the known (or potential) impact of a given SNP is presented to the healthcare professional (described below in Table 1). For example, if a patient is prescribed a drug where an adverse response has been associated with one or more specific genotypes, then the patient's electronic health record (EHR) simply indicates that the patient is “at risk for an adverse response due to genomic information” and make a recommendation to choose an alternate drug (and provide an alternate drug if one is available one is available) and/or reduce the dose of the drug. This specific example, as well as many others, has recently been demonstrated in the clinical literature. Drugs are metabolized endogenously by a series of enzymes collectively referred to as the cytochrome P-450 system. These enzymes are further characterized into sub-groups named CYPIAI, CYP2D6, etc. Meur et al., (2006) demonstrated that the metabolic activity and oral clearance of the immunosuppressant, sirolimus, is decreased in patients with CYP3A5*3 single-nucleotide polymorphism and further suggested that prior dose adjustments should be made in patients with this SNP. However, the technology for routinely implementing such a dose adjustment does not currently exist. Secondly, the initial commercially-viable implementation of a clinical genomics system involved drug safety issues and be administered through pharmacy prescription systems. This initial implementation of a pharmacogenomic system utilizes SNPs that have an established link to drug safety outcomes and therefore can include information-based guidance to patients harboring SNPs relevant to drug safety (supporting for both the physician and pharmacist), exploit a prescription/dispensing system that is already guided by an information system, and inherently does not involve SNPs poorly linked to disease risk and/or does not provide insight on how a physician or pharmacist should alter treatment. Furthermore, this near-term implementation provides a cultural shift in pharmaceutical drug development whereby new drug indications use genomic screening to ensure safety and efficacy, ultimately involving clinical drug development (phase I-IV) to be limited to patients with specific SNP genotypes to increase the overall safety and efficacy of new drug entities.

### Point-of-Care Utilization of Genomics: Physician's Office, Hospital, Pharmacy and Consumer.

This issue continues the rationale for a near-term implementation of clinical genomics in drug safety by allowing pharmacists to be the proprietors of genomic information and exploiting the interconnectivity of pharmacy information systems to allow access to patient genomic information across the country. As many more SNPs are ultimately derived for each patient, a more secure healthcare information system includes SNPs relevant to disease predisposition as they are established through translational research. As discussed later, the translational research that involves linking known SNPs to healthcare outcomes are facilitated through the use of the near-term implementation genotyping system.

### Capitalism & Pharmaceuticals: Risks and Returns on Investment in Genomic-Based Laboratories and Information Systems.

The implementation of a drug safety clinical genomic system provides an overall return on investment for the healthcare community in the near-term. This is because the system utilizes SNPs that have an established link to drug safety outcomes and therefore can include information-based guidance to patients that possess SNPs relevant to drug safety (i.e. decision support for both the physician and pharmacist), exploit a prescription/dispensing system that is already guided by an information system, and provide a cultural shift in pharmaceutical drug development whereby new drug indications can require genomic screening to increase the overall safety and efficacy of new drug entities.

### Translational Research: Establishing Linkages Between Allelic Information and Healthcare Outcomes.

This logistical barrier to the overall impact of genotypic information in the clinic involves a disparity between discovering (or uncovering) linkages between known SNPs and human health, which requires a large collection of known SNPs from a wide variety of patients (including their health records within one or more data standards), and a method upon how to rationalize the collection of known SNPs from a wide variety of patients. In other words, statistically significant linkages between known SNPs and health outcomes can be achieved if a large collection of SNPs from normal and diseased patients is available for data mining. Furthermore, this requires that the disease-relevant information and other meta data types be available within data standard formats to allow for data mining, which is the fundamental structure of an EHR. The near-term drug safety system that integrates known SNPs with prescription drug indications also facilitates the acquisition of many other known SNPs that are NOT relevant to drug safety for the purposes of epidemiological research. In other words, patients undergoing genotyping for drug safety have the option (ideally with incentives) to be genotyped for thousands of other known SNPs within their own genome to facilitate health outcomes research, ultimately to benefit themselves and society. This involves an anonymous contribution of SNP and EHR data to a specialized data management system dedicated to identifying SNP-based risk assessment through the discovery of statistically significant linkages to other health outcomes such as diabetes, cancer, mental disorders, age-related disorders, etc. This concept gives rise to an oversight committee that governs data mining and statistical methods to establish “accepted” links between SNPs and health outcomes, and “approves” new linkages as they are discovered, proven and published. Data management can be viewed along two perspectives, where the overall concept of “informational hierarchy” is used to describe both data concepts and data schemas (moving left to right in Table 1), which then define levels of information access (privacy & security) and levels of bioinformatics knowledge (raw biotechnology data to DNA sequence to protein sequence to physiological effect). This informational hierarchy (Table 1) is also organized vertically (top to bottom) to depict data transformations from raw data (biotechnology and DNA analysis data) into usable information (bioinformatics) and comprehensible knowledge (impact on human health).

TABLE 1
Information Hierarchy within a Clinical Genotyping Information System

| | | Access and | |
|---|---|---|---|
| Conceptual | Data Schema | Privacy | Bioinformatics |
| Perspective | Perspective | Perspective | Perspective |
| Data | Physical Data | Laboratory | Raw Data (DNA) |
| Information | Conceptual Data | Bioinformatic | DNA Sequence |
| | | Statistics | Bioinformatics |
| | | Epidemiology | Genomics and |
| | | | Ontology |
| Knowledge | User View | Healthcare data | Protein Sequence |
| | | Management | Enzyme |
| | | Applications | Biochemistry |
| | | | Receptor |
| | | | Biochemistry |
| Comprehension | Consumer View | Patient | Physiological |
| | | | Effect Impact on |
| | | | Healthcare |

### Clinical Genotyping for Drug Safety

### System-Wide Operations

### Patient-Controlled Access

The ethical concerns to genotyping in the clinic, which are also applicable to electronic health records in general, are essentially privacy and security. The benefits of incorporating genotyping (genetic information) in therapeutics and medicine are questioned when the risk of ‘information abuse’ is considered. For example, a patient may be unwilling to utilize the benefits of genotyping if they fear that their employer and/or insurance provider can utilize the same information to (accurately or inaccurately) predict the patient's future health status. This dilemma involves both societal and genetic components. At the genetic level, the validity of extrapolative health assessment based solely on genotypic data has not been broadly established, and is limited to a few known\genetic diseases. Therefore any long-term claims to health status for the majority of the population would be invalid at this point in time. Yet, it should be noted that the risk of adverse drug response based on known SNPs in drug metabolism enzymes has been established (see Table 2), and represents the near-term benefit to clinical genotyping.

TABLE 2
Representative Drug Metabolizing Enzymes
Associated with Adverse Drug Response

| | | Nucleotide | Enzyme Activity | Impact on | Common Drugs |
|---|---|---|---|---|---|
| CYP Family | Allele | Change | Change | AUC | Affected |
| 1A2 | CYP1A2*1C | −3860G > C | Decreases | Increases | Aminophylline |
| | | | | | Betaxolol |
| | | | | | Caffeine |
| | | | | | Flutamide |
| | | | | | Propranolol |
| 2C9 | CYP2C9*3A | 1075A > C | Decreases | Increases | Amiodarone |
| | | | | | Fluoxetine |
| | | | | | Glimepiride |
| | | | | | Warfarin |
| 3A4 | CYP3A4*18A | 878 T > C | Increases | Decreases | Atorvastatin |
| | | | | | Carbamazepine |
| | | | | | Clarithromycin |
| | | | | | Diltiazem |
| | | | | | Losartan |

Furthermore, note that the use of the term SNP (single nucleotide polymorphism) herein includes nucleotide base substitutions and single base deletions/substitutions within the human genome. In addition, knowledge of this predisposition does not represent association with other health risks. Thus knowledge of the risk of adverse drug response is a benefit to the patient, employer and insurance provider since overall healthcare costs would be minimized by avoiding adverse drug reactions. Allowing the patient to control external access to their genotypic data within this categorical distinction (e.g. “adverse drug response risk” data access=yes; “general health risk” data access=no) positively contributes to the adoption and success of genotyping in the clinic which is a natural artifact of utilizing the hierarchy described in Table 1.

While the inventions have been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

We claim:

1. A system for predicting a risk of adverse drug reactions to one or more drugs for a patient wherein the system comprises:
a. a digital apparatus;
b. an EHR of said patient;
c. a Genotypic Record of said patient;
d. at least one Human Genotypic Database (HGD) module, wherein the HGD comprises a collection of genotypic information for established linkages between known SNPs, at least one data import module and at least one data quality control module;
e. a RISK database module, wherein the RISK database module comprises a collection of established SNP-risk linkages and detailed information about each linkage to determine the genetic information and the adverse drug reaction phenotypic information for one or more patients;
f. a drug database comprising pharmacodynamic parameters and pharmacokinetic parameters regarding one or more drugs; and
g. an output to said digital apparatus of an analysis of the predicted risk of adverse drug reactions to one or more drugs for said patient based on analysis of said patient's said genotypic record and said EHR with said at least one HGD, said RISK database and said drug database.

2. The system of claim 1, wherein said system identifies information about the risk of adverse drug reactions at the time of drug dispensing based on analysis of said patient's said genotypic record and said EHR with said at least one HGD, said RISK database and said drug database.

3. The system of claim 1, wherein said system identifies information about the risk of drug-drug interaction risk at the time of drug dispensing based on analysis of said patient's said genotypic record and said EHR with said at least one HGD, said RISK database and said drug database.

4. The system of claim 1, wherein said system identifies information about the risk of drug-gene interaction risk at the time of drug dispensing based on analysis of said patient's said genotypic record and said EHR with said at least one HGD, said RISK database and said drug database.

5. The system of claim 1, wherein said system identifies information about the risk of drug-xenobiotic interaction risk at the time of drug dispensing based on analysis of said patient's said genotypic record and said EHR with said at least one HGD, said RISK database and said drug database.

6. The system of claim 1, wherein said digital apparatus informs a user of increased adverse drug reaction risk based on analysis of said patient's said genotypic record and said EHR with said at least one HGD, said RISK database and said drug database.

7. The system of claim 1, wherein said system suggests one or more alternate drug options for said patient based on said patient's said genotypic record and said EHR that harbors genetic evidence for increased risk of an adverse drug reaction to one or more prescribed drugs.

8. The system of claim 1, wherein said system calculates a change in drug clearance and impact on said patient's drug plasma area under the curve (AUC) based on analysis of said patient's said genotypic record and said EHR with said at least one HGD, said RISK database and said drug database.

9. The system of claim 1, wherein said system estimates a risk of reaching the minimum toxic concentration in plasma in said patient for a prescribed drug based on analysis of said patient's said genotypic record and said EHR with said at least one HGD, said RISK database and said drug database.

10. The system of claim 1, wherein said system identifies if said patient lacks sufficient genomic information in said patient's said HGD and EHR to predict or assess a risk of adverse drug reactions.

11. The system of claim 1, wherein said system provides a patient with a genetic screening of said patient's genotypic record and EHR at the time of a prescription being filled.

12. The system of claim 1, wherein said system prioritizes a need for genetic screening for said patient based on a therapeutic index of a prescribed drug and a drug's overall risk of adverse reactions.

13. The system of claim 1, wherein said system prioritizes the need for genetic screening for a patient based on the oral bioavailability of a prescribed drug and said drug's overall risk of adverse reactions.

14. The system of claim 1, further comprising a system for increasing the frequency of organ-specific toxicity screening based on patient-specific genomic information.

15. The system of claim 1, further comprising a system for enabling pharmacovigilance where short-term and long-term drug safety issues and outcomes are predicted, or more frequently monitored, or identified to be independent of patient-specific drug metabolism capabilities identified through genomic screening.

16. The system of claim 1, further limiting or altering dosing regimens for said patient, based on analysis of said patient's said genotypic record and said EHR with said at least one HGD, said RISK database and said drug database.

17. The system of claim 1, comprising limiting or altering dosing regimens for said patient, based on analysis of said patient's said genotypic record and said EHR with said at least one HGD, said RISK database and said drug database.

18. The system of claim 1, wherein said patient has control of access to said patient's said genotypic record and said EHR.

19. The system of claim 1, further comprising a results sharing module to allow the user of said apparatus to report any changes to the drug prescribed for said patient.

20. The system of claim 1, further comprising an automated guidance module used for repeated testing of said genotypic record of said patient to detect an abnormal state.

21. The system of claim 20, wherein when said abnormal state is detected said system suggests altering therapeutic methods.

22. The system of claim 1, further comprising a module for periodically reconciling said patient genotypic record and said patient EHR with information in said RISK database to determine if the patient should have additional DNA testing.

23. The system of claim 1, wherein said system provides guidance on the safest and most effective method of dosing said one or more drugs comprising oral dosing, subcutaneous dosing, or intravenous dosing.

24. A method for predicting a risk of adverse drug reaction to one or more drugs for a patient comprising:
a. an EHR of said patient;
b. a Genotypic Record of said patient;
c. at least one Human Genotypic Database (HGD) module, wherein the HGD comprises a collection of genotypic information for established linkages between known SNPs, at least one data import module and at least one data quality control module;
d. a RISK database module, wherein the RISK database module comprises a collection of established SNP-risk linkages and detailed information about each linkage to determine the genetic information and the adverse drug reaction phenotypic information for one or more patients;
e. a drug database comprising pharmacodynamic parameters and pharmacokinetic parameters regarding one or more drugs; and
f. an output to a digital apparatus of an analysis of the predicted risk of adverse reaction to one or more drugs for said patient based on analysis of said patient's said genotypic record and said EHR with said at least one HGD, said RISK database and said drug database.

25. The method of claim 24, wherein said method identifies information about the risk of adverse drug reactions at the time of drug dispensing based on analysis of said patient's said genotypic record and said EHR with said at least one HGD, said RISK database and said drug database.

26. The method of claim 24, wherein said method identifies information about the risk of drug-drug interaction risk at the time of drug dispensing based on analysis of said patient's said genotypic record and said EHR with said at least one HGD, said RISK database and said drug database.

27. The method of claim 24, wherein said method identifies information about the risk of drug-gene interaction risk at the time of drug dispensing based on analysis of said patient's said genotypic record and said EHR with said at least one HGD, said RISK database and said drug database.

28. The method of claim 24, wherein said method identifies information about the risk of drug-xenobiotic interaction risk at the time of drug dispensing based on analysis of said patient's said genotypic record and said EHR with said at least one HGD, said RISK database and said drug database.

29. The method of claim 24, wherein said method informs a user of increased adverse drug reaction risk based on analysis of said patient's said genotypic record and said EHR with said at least one HGD, said RISK database and said drug database.

30. The method of claim 24, wherein said method suggests alternate one or more drug options for said patient based on said patient's said genotypic record and said EHR that harbors genetic evidence for increased risk of an adverse drug reaction to one or more prescribed drug.

31. The method of claim 24, wherein said method calculates a change in drug clearance and impact on said patient's drug plasma area under the curve (AUC) based on analysis of said patient's said genotypic record and said EHR with said at least one HGD, said RISK database and said drug database.

32. The method of claim 24, wherein said method estimates a risk of reaching the minimum toxic concentration in plasma in said patient for a prescribed drug based on analysis of said patient's said genotypic record and said EHR with said at least one HGD, said RISK database and said drug database.

33. The method of claim 24, wherein said method identifies if said patient lacks sufficient genomic information in said patient's said genotypic record and EHR to predict or assess a risk of adverse drug reactions.

34. The method of claim 24, wherein said method provides a patient with a genetic screening of said patient's genotypic record and EHR at the time of a prescription being filled.

35. The method of claim 24, wherein said method prioritizes the need for genetic screening for said patient based on a therapeutic index of a prescribed drug and a drug's overall risk of adverse reactions.

36. The method of claim 24, wherein said method prioritizes the need for genetic screening for a patient based on the oral bioavailability of a prescribed drug and said drug's overall risk of adverse reactions.

37. The method of claim 24, further comprising a method for increasing the frequency of organ-specific toxicity screening based on patient-specific genomic information.

38. The method of claim 24, further comprising a method for enabling pharmacovigilance where short-term and long-term drug safety issues and outcomes are predicted, or more frequently monitored, or identified to be independent of patient-specific drug metabolism capabilities identified through genomic screening.

39. The method of claim 24, comprising limiting or altering dosing regimens for said patient, based on analysis of said patient's said genotypic record and said EHR with said at least one HGD, said RISK database and said drug database.

40. The method of claim 24, wherein said patient has control of access a user has to the said patient's said genotypic record and said EHR.

41. The method of claim 24, further comprising a results sharing module to allow the user of said apparatus to report any changes to the drug prescribed for said patient.

42. The method of claim 24, further comprising an automated guidance module for repeated testing of said genotypic record of said patient to detect an abnormal state.

43. The method of claim 42, wherein when abnormal state is detected said system suggests altering therapeutic methods.

44. The method of claim 24, further comprising a module for periodically reconciling said patient genotypic record and said patient EHR with information in said RISK database to determine if said patient should have additional DNA testing.

45. The method of claim 24, wherein said method provides guidance on the safest and most effective method of dosing said one or more drugs comprising oral dosing, subcutaneous dosing, or intravenous dosing.

46. A system for predicting a therapeutic response to one or more drugs for a patient wherein the system comprises:
a. a digital apparatus;
b. an EHR of said patient;
c. a Genotypic Record of said patient;
d. at least one Human Genotypic Database (HGD) module, wherein the HGD comprises a collection of genotypic information for established linkages between known SNPs, at least one data import module and at least one data quality control module;
e. a RISK database module, wherein the RISK database module comprises a collection of established SNP-risk linkages and detailed information about each to determine the genetic information and the therapeutic response phenotypic information for one or more patients;
f. a drug database comprising pharmacodynamic parameters and pharmacokinetic parameters regarding one or more drugs; and
g. an output to said digital apparatus of an analysis of the predicted therapeutic responses to one or more drugs for said patient based on analysis of said patient's said genotypic record and said EHR with said at least one HGD, said RISK database and said drug database.

47. A method for predicting a therapeutic response to one or more drugs for a patient wherein the method comprises:
a. an EHR of said patient;
b. a Genotypic Record of said patient;
c. at least one Human Genotypic Database (HGD) module, wherein the HGD comprises a collection of genotypic information for established linkages between known SNPs, at least one data import module and at least one data quality control module;
d. a RISK database module, wherein the RISK database module comprises a collection of established SNP-risk linkages and detailed information about each linkage to determine the genetic information and the therapeutic response phenotypic information for one or more patients.
e. a drug database comprising pharmacodynamic parameters and pharmacokinetic parameters regarding one or more drugs;
f. an output to said digital apparatus of an analysis of the predicted therapeutic responses to one or more drugs for said patient based on analysis of said patient's said genotypic record and said EHR with said at least one HGD and said RISK database.

48. A system for predicting an adverse drug reaction and therapeutic response to one or more drugs for a patient wherein the system comprises:
a. a digital apparatus;
b. an EHR of said patient;
c. a Genotypic Record of said patient;
d. at least one Human Genotypic Database (HGD) module, wherein the HGD comprises a collection of genotypic information for established linkages between known SNPs, at least one data import module and at least one data quality control module;
e. a RISK database module, wherein the RISK database module comprises a collection of established SNP-risk linkages and detailed information about each linkage to determine the genetic information and the adverse drug reaction phenotypic information and therapeutic response for one or more patients;
f. a drug database comprising pharmacodynamic parameters and pharmacokinetic parameters regarding one or more drugs; and
g. an output to said digital apparatus of an analysis of the predicted adverse drug reaction and therapeutic responses to one or more drugs for said patient based on analysis of said patient's said genotypic record and said EHR with said at least one HGD, said RISK database and said drug database.

49. A method for predicting an adverse drug reaction and therapeutic response to one or more drugs for a patient wherein said method comprises:
a. an EHR of said patient;
b. a Genotypic Record of said patient;
c. at least one Human Genotypic Database (HGD) module, wherein the HGD comprises a collection of genotypic information for established linkages between known SNPs, at least one data import module and at least one data quality control module;
d. a RISK database module, wherein the RISK database module comprises a collection of established SNP-risk linkages and detailed information about each linkage to determine the genetic information and the adverse drug reaction and therapeutic response phenotypic information for one or more patients;
e. a drug database comprising pharmacodynamic parameters and pharmacokinetic parameters regarding one or more drugs; and
f. an output to said digital apparatus of an analysis of the predicted therapeutic responses to one or more drugs for said patient based on analysis of said patient's said genotypic record and said EHR with said at least one HGD, said RISK database and said drug database.
